(19) United States
(12) Patent Application Publication
(10) Pub. No.: US 2011/0296076 A1
(43) Pub. Date: Dec. 1, 2011

(54) HYBRID DATA TRANSMISSION EXCHANGER AND HYBRID DATA TRANSMISSION METHOD

(76) Inventors: Kuei-Hsun HU, Jhubei City (TW); Sheng-Yung HUANG, Jhubei City (TW)

(21) Appl. No.: 12/857,993

(22) Filed: Aug. 17, 2010

(30) Foreign Application Priority Data
May 26, 2010 (TW) 099116804

(51) Int. Cl. G06F 13/00

(52) U.S. Cl. 710/316

(57) ABSTRACT

The present invention discloses a hybrid data transmission exchanger and a hybrid data transmission method, whereby hosts can access storage units and share data. The hybrid data transmission exchanger comprises an embedded central processing unit, a virtual bridge/switch unit, an optical fiber network connection unit and an Ethernet connection unit. The embedded central processing unit is connected with the storage units and detects the virtual bridge/switch unit, optical fiber network connection unit and Ethernet connection unit to detect the connection states of a host. A host can directly access the storage units via the optical fiber network connection unit or the Ethernet connection unit. When a host is linked to the exchanger via a PCIe interface, the virtual bridge/switch unit converts an address area and a request identification code of the host to correspond to the embedded central processing unit, whereby the host can access storage units.

### BACKGROUND OF THE INVENTION

1. Field of the Invention

The present invention relates to a data transmission bus exchanger, particularly to a hybrid data transmission exchanger and a hybrid data transmission method, wherein the transmission interface integrates with PCIe to access storage devices.

2. Description of the Related Art

To effectively utilize data and reduce cost, several hosts usually share one or more storage devices via exchanges.

The current exchangers primarily use optical fibers or Ethernet as the transmission interface. Optical fibers implement 2 Gb/4 Gb/8 Gb data transmission rates. The Ethernet implements 10/100 Mb/1/10-gigabit data transmission rates. The multimedia data is growing massive and diversified day by day and has gradually overburdened the optical fiber or Ethernet interface. Further, the optical fiber or Ethernet interface has limited compatibility and expandability. Furthermore, data is likely to miss in the abovementioned interfaces. Besides, signal and protocol conversions are needed in bridging the system bus of the computer and the access interface of the storage device. However, signal and protocol conversions degrade data transmission performance.

To overcome the abovementioned problems, the present invention adopts a standard PCIe (Peripheral Component Interconnect express) interface as the data transmission interface of the storage-access device of the host, whereby multimedia data can be fast transmitted. As the PCIe interface is an internal bus, it can directly communicate with the central processing unit of the host. Thereby, the present invention is exempted from performance degrade caused by signal and protocol conversions. In addition to the PCIe interface, the present invention also integrates with the traditional optical-fiber exchanger and Ethernet exchanger and uses the optical-fiber transmission interface and the Ethernet transmission interface to transmit data. Therefore, the present invention has superior compatibility and expandability. Further, the present invention cooperates with PCIe storage units to form a PCIe storage area network. Thus is achieved a high-speed storage network.

### SUMMARY OF THE INVENTION

The primary objective of the present invention is to provide a hybrid data transmission exchanger and a hybrid data transmission method, which adopt a standard PCIe interface as the transmission interface, whereby is greatly increased the data transmission rate, and whereby is implemented a high-speed storage network.

Another objective of the present invention is to provide a hybrid data transmission exchanger and a hybrid data transmission method, wherein the hybrid data transmission exchanger integrates with the optical-fiber and Ethernet transmission interfaces and thus adapts to the existing exchangers, wherefore the present invention has superior compatibility and expandability.

To achieve the abovementioned objectives, the present invention proposes a hybrid data transmission exchanger, whereby at least one host can access at least one storage unit. The hybrid data transmission exchanger of the present invention comprises an embedded CPU (Central Processing Unit), a virtual bridge/switch unit, an optical fiber network connection unit and an Ethernet connection unit. The embedded CPU is electrically connected with storage units, the virtual bridge/switch unit, the optical fiber network connection unit and the Ethernet connection unit. A host can directly access the storage units via the optical fiber network connection unit or the Ethernet connection unit. When a host is linked to the hybrid data transmission exchanger via a PCIe interface, the virtual bridge/switch unit converts an address area and a request identification code of the host to correspond to the embedded central processing unit, whereby the host can access storage units.

The present invention also proposes a hybrid data transmission method, which comprises steps: an embedded central processing unit examining connection states of a host to detect whether the host is linked to an optical fiber network connection unit, an Ethernet connection unit or a virtual bridge/switch unit; the host directly accessing at least one storage unit when the host is linked to the optical fiber network connection unit or the Ethernet connection unit; the virtual bridge/switch unit converting an address area and a request identification code of the host to enable the host to access at least one storage unit when the host is linked to the virtual bridge/switch unit; and the host sending out an access-completion message when the host has completed accessing the storage unit.

Below, the embodiments are described in detail in cooperation with the attached drawings to make easily understood the objectives, technical contents, characteristics and accomplishments of the present invention.

### BRIEF DESCRIPTION OF THE DRAWINGS

FIG. 1 is a block diagram schematically showing the architecture of a hybrid data transmission exchanger according to the present invention;

FIG. 2 is a block diagram schematically showing the system administration architecture of a hybrid data transmission exchanger according to the present invention;

FIG. 3 is a flowchart of a data access/transmission process according to the present invention; and

FIG. 4 is a block diagram schematically showing an application of the present invention to a storage area network.

### DETAILED DESCRIPTION OF THE INVENTION

The present invention proposes a hybrid data transmission exchanger, wherein several hosts can access storage devices via an optical fiber network, an Ethernet network, or a PCIe interface, wherefore the data can be transmitted at very high speed. The technical contents of the present invention are described in detail with the embodiments below.

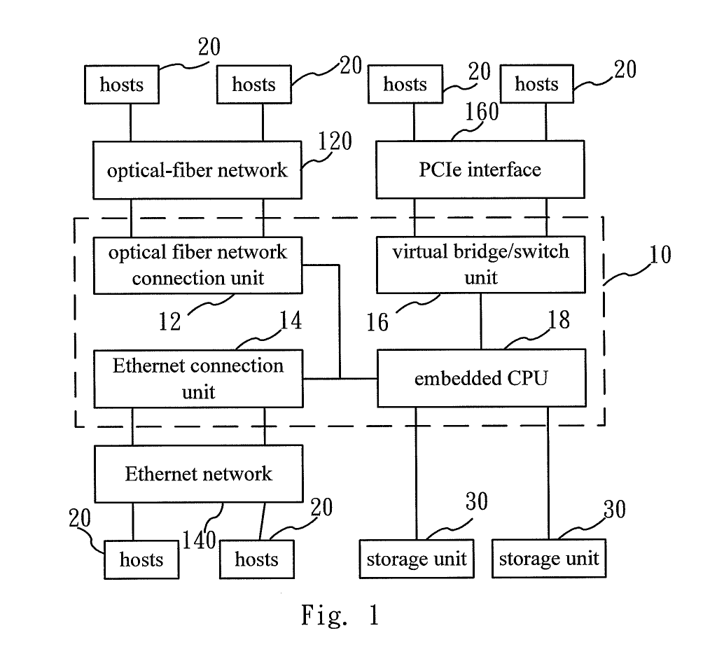

Refer to FIG. 1 a block diagram schematically showing the architecture of a hybrid data transmission exchanger according to the present invention. The hybrid data transmission exchanger 10 of the present invention comprises an embedded CPU (Central Processing Unit) 18, an optical fiber network connection unit 12, an Ethernet connection unit 14 and a virtual bridge/switch unit 16, wherein the optical fiber network connection unit 12, the Ethernet connection unit 14 and the virtual bridge/switch unit 16 are all electrically connected with the embedded CPU 18. A plurality of hosts 20 are respectively linked to the optical fiber network connection unit 12, the Ethernet connection unit 14 and the virtual bridge/switch unit 16 via an optical-fiber network 120, an Ethernet network 140 and a PCIe interface 160, whereby the hosts 20 can access storage units 30 linked to the embedded CPU 18, such as fiber channel storage devices, iSCSI (Internet Small Computer System Interface) storage devices or PCIe storage devices.

The system architecture of the present invention has been described hereinbefore. The system administration levels of the hybrid data transmission exchanger 10 and the operations of the optical fiber network connection unit 12, the Ethernet connection unit 14 and the virtual bridge/switch unit 16 will be described thereinafter.

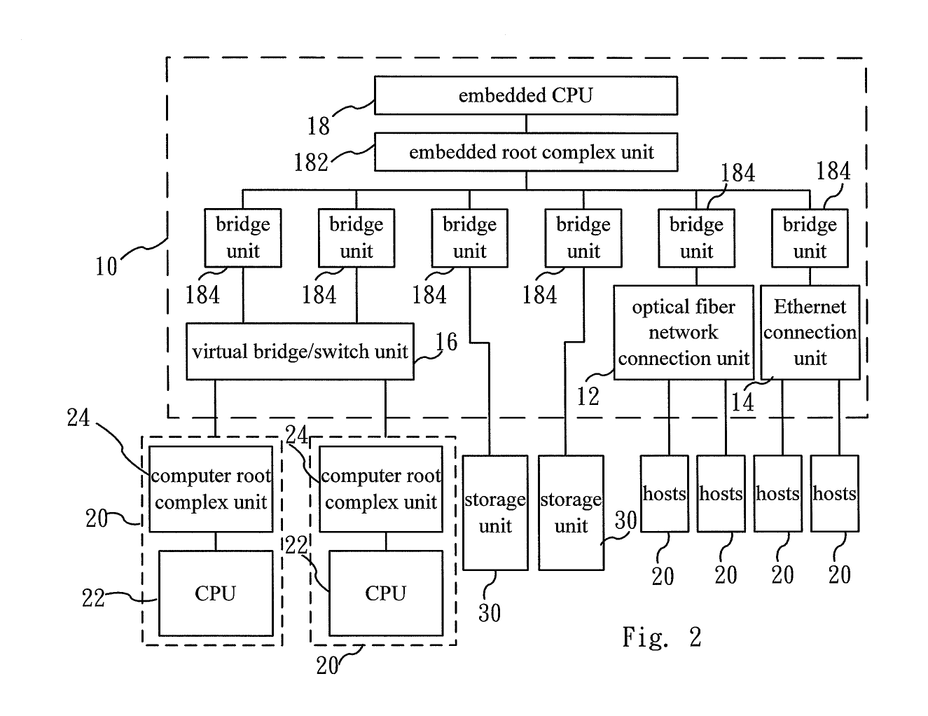

Refer to FIG. 2, and refer to FIG. 1 again. The embedded CPU 18 is electrically connected with an embedded root complex unit 182. A plurality of bridge units 184 is also electrically connected with the embedded root complex unit 182. The bridge units 184 are further electrically connected with the storage units 30, the optical fiber network connection unit 12, the Ethernet connection unit 14 and the virtual bridge/switch unit 16 respectively. Thus is formed a hierarchical structure. The hosts 20, which are respectively linked to the optical fiber network connection unit 12 and the Ethernet connection unit 14 via the optical-fiber network 120 and the Ethernet network 140, can directly access the storage units 30 and exchange data with the storage units 30.

The PCIe interface 160 is a high-speed point-to-point channel. The hosts 20, which are linked to the hybrid data transmission exchanger 10 via the PCIe interface 160, need the virtual bridge/switch unit 16 as the transmission medium to access the storage units 30. Each host 20 includes at lest one CPU 22 and a computer root complex unit 24. The computer root complex unit 24 is hierarchically electrically connected with the CPU 22. In such a case, the host 20 is linked to the hybrid data transmission exchanger 10 via connecting the computer root complex unit 24 and the virtual bridge/switch unit 16. For the hybrid data transmission exchanger 10 and the host 20, the virtual bridge/switch unit 16 is regarded as a device. When the embedded CPU 18 or the CPU 22 is scanning for devices or bridges and has found the virtual bridge/switch unit 16, the virtual bridge/switch unit 16 is regarded as a terminal because it is a device. Therefore, the virtual bridge/switch unit 16 can isolate both sides lest they conflict. When one host 20 intends to access one storage unit 30, the virtual bridge/switch unit 16 converts the address area and the request identification code of the CPU 22 of the host 20 to correspond to the address area and the request identification code of the embedded CPU 18. Thereby, the hosts 20, which are linked to the hybrid data transmission exchanger 10 via the PCIe interface 160, can access the storage units 30.

Above has been described in detail the system administration architecture of the present invention. Below is to be described in detail the data transmission process of the present invention.

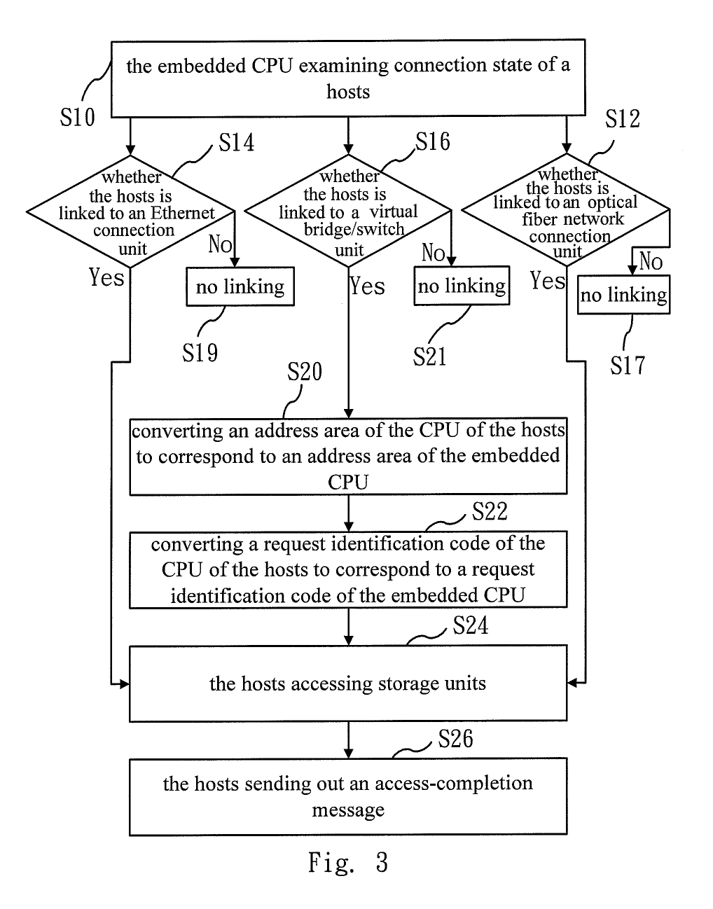

Refer to FIG. 3 a flowchart of a data access/transmission process according to the present invention, and refer to FIG. 1 again. In Step S10, the embedded CPU 18 scans the connection ports of the hybrid data transmission exchanger 10 to examine the connection states of the hosts 20 to detect whether the hosts 20 are linked to the optical fiber network connection unit 12 (Step S12), the Ethernet connection unit 14 (Step S14) or the virtual bridge/switch unit 16 (Step S16). If one host 20, which is connected with the optical-fiber network 120, is linked to the optical fiber network connection unit 12, the host 20 can directly access the storage units 30 (Step S24). If the host 20, which is connected with the optical-fiber network 120, is not linked to the optical fiber network connection unit 12, the host 20 cannot access the storage units 30 (Step S17). If one host 20, which is connected with the Ethernet network 140, is linked to the Ethernet connection unit 14, the host 20 can directly access the storage units 30 (Step S24). If the host 20, which is connected with the Ethernet network 140, is not linked to the Ethernet connection unit 14, the host 20 cannot access the storage units 30 (Step S19).

If one host 20, which is connected with the PCIe interface 160, is linked to the virtual bridge/switch unit 16 of the hybrid data transmission exchanger 10, the virtual bridge/switch unit 16 converts the address area of the CPU 22 of the host 20 to correspond to the address area of the embedded CPU 18 (Step S20). Next, the virtual bridge/switch unit 16 converts the request identification code of the CPU 22 of the host 20 to correspond to the request identification code of the embedded CPU 18 (Step S22). Then, the host 20 can access the storage units 30 (Step S24). If one host 20, which is connected with the PCIe interface 160, is not linked to the virtual bridge/switch unit 16 of the hybrid data transmission exchanger 10, the host 20 cannot access the storage units 30 (Step S21).

After having completed accessing the storage unit 30, the host 20 sends out an access-completion message (Step S26).

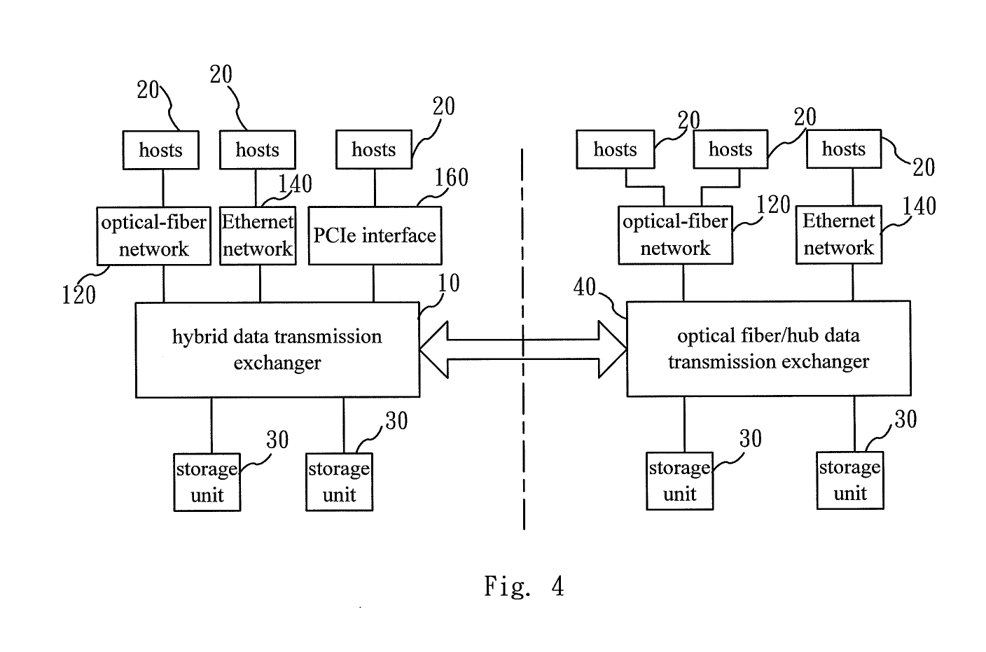

Refer to FIG. 4 a block diagram schematically showing an application of the present invention to a storage area network (SAN). The storage area network (SAN) implemented by the hybrid data transmission exchanger 10 of the present invention is compatible with a storage area network implemented by a conventional optical fiber/hub data transmission exchanger 40. The hosts 20, which are respectively linked to the hybrid data transmission exchanger 10 via the optical-fiber network 120, the Ethernet network 140 and the PCIe interface 160, can be further linked to an optical fiber/hub data transmission exchanger 40 by the hybrid data transmission exchanger 10 and then access the storage units 30 linked to the optical fiber/hub data transmission exchanger 40. On the other hand, the hosts 20, which are respectively linked to the optical fiber/hub data transmission exchanger 40 via an optical-fiber network 120 and an Ethernet network 140, can be further linked to the hybrid data transmission exchanger 10 by the optical fiber/hub data transmission exchanger 40 and then access the storage units 30 linked to the hybrid data transmission exchanger 10. Therefore, the hosts 20, which are respectively in the two different groups, can directly access the storage units 30 in the other group. Besides, several hybrid data transmission exchangers 10 can be linked to each other to form a storage area network, whereby the hosts 20 can access storage units 30 at higher speed.

From the embodiments described above, it is known that the present invention proposes a bus exchanger and a data transmission method using the same, wherein the optical-fiber network 120, the Ethernet network 140 and the PCIe interface 160 are integrated for data transmission, and wherein a plurality of hosts 20 can access data via the PCIe interface 160 in addition to via the optical-fiber network 120 and the Ethernet network 140, whereby is greatly promoted the data transmission performance. Further, the present invention can easily integrate with the existing bus exchangers and extensively apply to general electronic devices and workstations.

The embodiments described above are only to demonstrate the technical contents and characteristics of the present invention to enable the persons skilled in the art to understand, make, and use the present invention. However, it is not intended to limit the scope of the present invention. Any equivalent modification or variation according to the spirit of the present invention is to be also included within the scope of the present invention.

What is claimed is:

1. A hybrid data transmission exchanger, via which at least one host accesses at least one storage unit, comprising
an embedded central processing unit electrically connected with said storage unit;
a virtual bridge/switch unit electrically connected with said embedded central processing unit and converting an address area and a request identification code of one said host to correspond to an address area and a request identification code of said embedded central processing unit for accessing one said storage unit;
an optical fiber network connection unit electrically connected with said embedded central processing unit, whereby one said host accesses one said storage unit; and
an Ethernet connection unit electrically connected with said embedded central processing unit, whereby one said computer accesses one said storage unit.

2. The hybrid data transmission exchanger according to claim 1, wherein said storage unit is a fiber channel storage device, an iSCSI (Internet Small Computer System Interface) storage device or a PCIe (Peripheral Component Interconnect express) storage device.

3. The hybrid data transmission exchanger according to claim 1 further comprising an embedded root complex unit electrically connected with said embedded central processing unit and a plurality of bridge units, wherein said bridge units are respectively connected with said storage units, said virtual bridge/switch unit, said optical fiber network connection unit and said Ethernet connection unit, whereby said storage units, said virtual bridge/switch unit, said optical fiber network connection unit and said Ethernet connection unit can be electrically connected with said embedded central processing unit via said embedded root complex unit and said bridge units.

4. The hybrid data transmission exchanger according to claim 1, wherein said host includes at least one central processing unit and a computer root complex unit, and wherein said host is electrically connected with said virtual bridge/switch unit via said computer root complex unit.

5. The hybrid data transmission exchanger according to claim 4, wherein said virtual bridge/switch unit converts an address area and a request identification code of said host to correspond to an address area and a request identification code of said embedded central processing unit.

6. The hybrid data transmission exchanger according to claim 1, wherein said host is linked to said optical fiber network connection unit via an optical fiber network to access said storage unit, or linked to said Ethernet connection unit via an Ethernet network to access said storage unit, or linked to said virtual bridge/switch unit via a PCIe interface to access said storage unit.

7. The hybrid data transmission exchanger according to claim 1, wherein a plurality of said hybrid data transmission exchangers is linked to implement a storage area network.

8. A hybrid data transmission method comprising steps:
examining connection states of a computer to detect whether said host is linked to an optical fiber network connection unit, an Ethernet connection unit or a virtual bridge/switch unit;
converting an address area and a request identification code of said host; and
said host accessing at least one storage unit.

9. The hybrid data transmission method according to claim 8, wherein in said step of examining connection states of a host, said host is linked to an optical fiber network connection unit via an optical fiber network, or linked to an Ethernet connection unit via an Ethernet network, or linked to a virtual bridge/switch unit via a PCIe (Peripheral Component Interconnect express) interface, and wherein an embedded central processing unit is used to detect said optical fiber network connection unit, said Ethernet connection unit and said virtual bridge/switch unit to detect connection states of said host, and wherein when said host is linked to said optical fiber network connection unit via said optical fiber network or linked to said Ethernet connection unit via said Ethernet network, said host can directly access said storage unit, and wherein when said host is linked to said virtual bridge/switch unit via said PCIe interface, said virtual bridge/switch unit converts an address area and a request identification code of at least one central processing unit of said host to correspond to an embedded central processing unit for accessing said storage unit.

10. The hybrid data transmission method according to claim 8 further comprising a step of sending out an access-completion message, wherein when having completed accessing said storage unit, said host sends out an access-completion message.

11. The hybrid data transmission method according to claim 8, wherein said storage unit is a fiber channel storage device, an iSCSI (Internet Small Computer System Interface) storage device or a PCIe storage device.

12. The hybrid data transmission method according to claim 9, wherein said embedded central processing unit is linked to a plurality of bridge units via an embedded root complex unit, and wherein said bridge units are respectively connected with said optical fiber network connection unit, said Ethernet connection unit, said virtual bridge/switch unit and said storage units, whereby said embedded central processing unit can detect said optical fiber network connection unit, said Ethernet connection unit and said virtual bridge/switch unit to detect connection states of said host via said embedded root complex unit and said bridge units.

13. The hybrid data transmission method according to claim 9, wherein said host has a computer root complex unit connected with said central processing unit of said host, wherein said host is linked to said virtual bridge/switch unit via said computer root complex unit.
